(19) United States
(12) Patent Application Publication
(10) Pub. No.: US 2026/0036183 A1
(43) Pub. Date: Feb. 5, 2026

(54) HYDRAULIC DAMPER AND VEHICLE

(71) Applicant: T-MAX (HANGZHOU) TECHNOLOGY CO., LTD., Hangzhou (CN)

(72) Inventors: Xinfa DU, Hangzhou (CN); Yongyong ZHAN, Hangzhou (CN); Ke WANG, Hangzhou (CN); Songfeng WANG, Hangzhou (CN); Lei YANG, Hangzhou (CN)

(21) Appl. No.: 19/287,709

(22) Filed: Jul. 31, 2025

(30) Foreign Application Priority Data
Jul. 31, 2024 (CN) 202411047201.7

(51) Int. Cl. F16F 9/34; F16F 9/32

(52) U.S. Cl. CPC F16F 9/34; F16F 9/3221

(57) ABSTRACT

Disclosed is a hydraulic damper. In some embodiments, a hydraulic damper includes a cylinder barrel, a piston valve, a piston rod, and a frequency selection valve. The piston valve is arranged inside the cylinder barrel and divides a chamber of the cylinder barrel into a compression chamber and a recovery chamber. The piston rod is threaded through the recovery chamber and coupled with the piston valve, and another end of the piston rod extends outside the cylinder barrel. A bypass flow channel is arranged inside the piston rod, and the bypass flow channel is in communication with the compression chamber. The frequency selection valve is arranged inside the recovery chamber and mounted on the piston rod and is spaced a preset distance from the piston valve along an axial direction of the piston rod. The frequency selection valve is in communication with another end of the bypass flow channel.

### CROSS-REFERENCE TO RELATED APPLICATIONS

This patent document claims priority to and benefits of Chinese Patent Application Serial No. 202411047201.7, filed on Jul. 31, 2024. The entire content of the aforementioned patent application is incorporated by reference for all purposes.

### TECHNICAL FIELD

This patent document relates to the field of damper technology, particularly to a hydraulic damper.

### BACKGROUND

A damper is a device that regulates airflow or controls the movement of fluids. Dampers can be used in a variety of applications, including but not limited to automotive suspension systems (e.g., shock absorbers), heating, ventilation, and air conditioning (HVAC) systems, and musical instruments (e.g., piano dampers).

### SUMMARY

Disclosed are devices, systems and methods for a hydraulic damper and vehicle incorporating a hydraulic damper in accordance with the present technology.

In some example embodiments of the disclosed technology, a hydraulic damper is provided. The hydraulic damper includes a cylinder barrel; a piston valve, arranged inside the cylinder barrel and slidable relative to the cylinder barrel with damping, and dividing a chamber of the cylinder barrel into a compression chamber and a recovery chamber, in which the compression chamber and the recovery chamber are filled with oil fluid; a piston rod having a first end threaded through the recovery chamber and coupled with the piston valve, and a second end extending outside the cylinder barrel, in which a bypass flow channel having a first end and a second end is arranged inside the piston rod, and the first end of the bypass flow channel is in communication with the compression chamber; and a frequency selection valve, arranged inside the recovery chamber and arranged on the piston rod, in which the frequency selection valve is spaced a preset distance from the piston valve along an axial direction of the piston rod, and the frequency selection valve is in communication with the second end of the bypass flow channel; in which in a case where an excitation frequency borne by the hydraulic damper is higher than a preset frequency, the frequency selection valve is opened to enable the bypass flow channel to be in communication with the recovery chamber, and in a case where an excitation frequency borne by the hydraulic damper is lower than the preset frequency, the frequency selection valve is closed to block the bypass flow channel from communicating with the recovery chamber.

In some example embodiments of the disclosed technology, a vehicle incorporating an example embodiment of a hydraulic damper is provided. The vehicle includes the hydraulic damper according to any one of the embodiments of the disclosed technology.

The subject matter described in this patent document can be implemented in specific ways that provide one or more of the following features.

### BRIEF DESCRIPTION OF THE DRAWINGS

FIG. 1 shows a diagram depicting a cross-sectional view of a hydraulic damper according to an example embodiment of the disclosed technology.

FIG. 2 shows a partial schematic diagram of a hydraulic damper (in a stationary state) according to an example embodiment of the disclosed technology.

FIG. 3 shows a partial schematic diagram of a hydraulic damper (in a first stage of a recovery process) according to an example embodiment of the disclosed technology.

FIG. 4 shows a partial schematic diagram of a hydraulic damper (in a second stage of a recovery process) according to an example embodiment of the disclosed technology.

FIG. 5 shows a partial schematic diagram of a hydraulic damper (in a third stage of a recovery process) according to an example embodiment of the disclosed technology.

FIG. 6 shows a partial schematic diagram of a hydraulic damper (in a fourth stage of a recovery process) according to an example embodiment of the disclosed technology.

FIG. 7 shows a partial schematic diagram of a hydraulic damper (in a compression process) according to an example embodiment of the disclosed technology.

FIG. 8 shows a diagram depicting a cross-sectional view of a frequency selection valve (without an upper valve cover, a lower valve cover, and a flexible membrane assembly) of a hydraulic damper according to an example embodiment of the disclosed technology.

FIG. 9 shows a diagram depicting a cross-sectional view of a flexible membrane assembly of a frequency selection valve of a hydraulic damper according to an example embodiment of the disclosed technology.

FIG. 10 shows a diagram depicting an overall cross-sectional view of a frequency selection valve of a hydraulic damper according to an example embodiment of the disclosed technology.

FIG. 11 shows an exploded diagram of a frequency selection valve of a hydraulic damper according to an example embodiment of the disclosed technology.

FIG. 12 shows an exploded diagram of a hydraulic damper according to an example embodiment of the disclosed technology.

FIG. 13 shows an exploded diagram of some parts of a hydraulic damper according to an example embodiment of the disclosed technology.

### DETAILED DESCRIPTION

Example embodiments of the disclosed technology are described in detail below, and examples of the embodiments are shown in the accompanying drawings. The embodiments described below with reference to the accompanying drawings are exemplary (i.e., examples) and intended to explain the disclosed technology and not be constructed as limiting the disclosed technology.

For vehicles, electromechanical equipment, bridges, or high-rise buildings that require vibration reduction, due to a strong randomness or strong nonlinear characteristics of the excitation source, the damping performance of the corresponding vibration reduction equipment should be automatically adjusted according to actual excitation properties.

At present, most of the methods used are to increase an electronic control system, and according to excitation situations and vibration reduction performance requirements, a controller controls a damping hole opening of the valve in the damping device, or controls a viscosity of the liquid in the damping device, in order to adjust performances of the damping device.

In related arts, there is a scheme of setting a frequency valve on the damper device, so that the damper device can adaptively adjust the damping according to the external excitation frequency, but the frequency selection valve of the damper device is usually provided in the compression chamber of the cylinder barrel and arranged at the end of the piston, which limits the mounting scenario and weakens the structural strength of the piston rod, resulting in a poor use effect.

Disclosed are devices, systems and methods for a hydraulic damper and vehicle incorporating a hydraulic damper in accordance with the present technology.

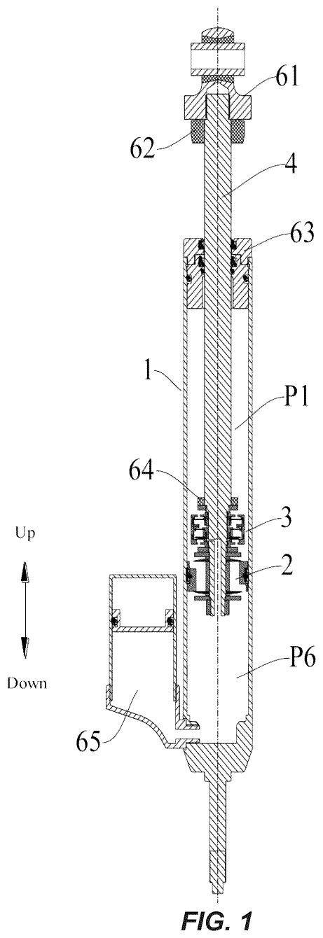

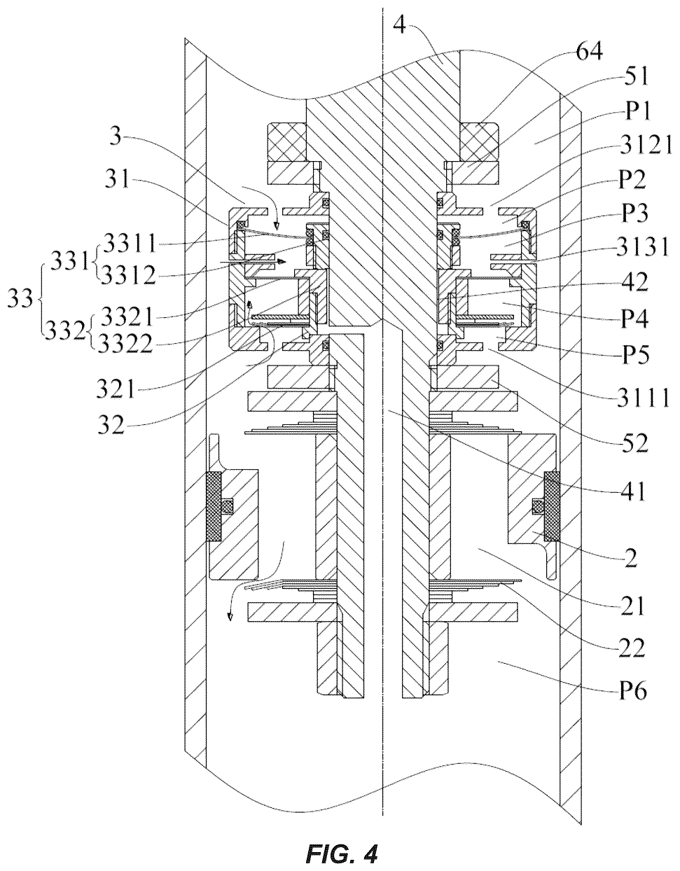

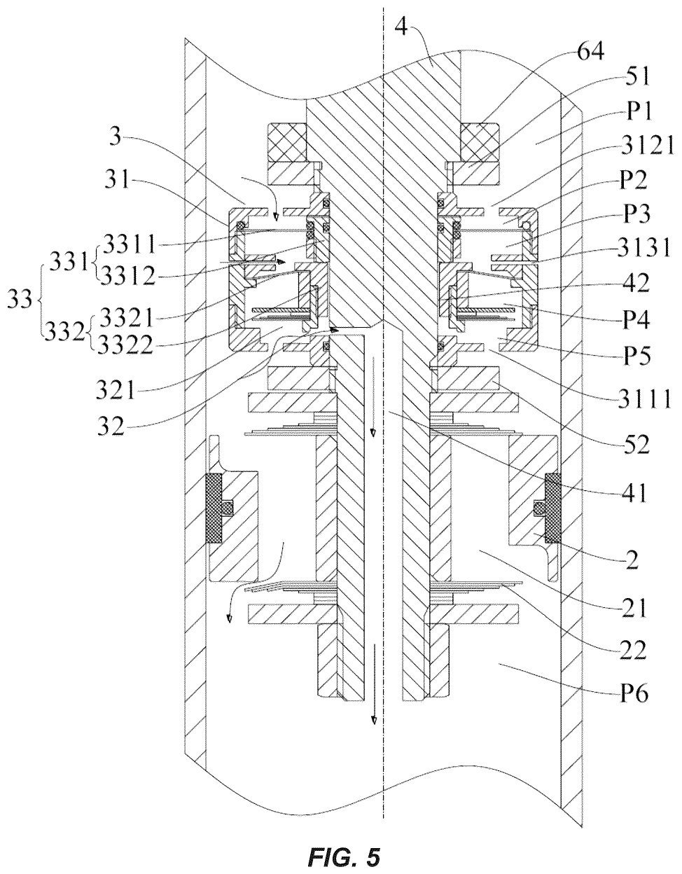

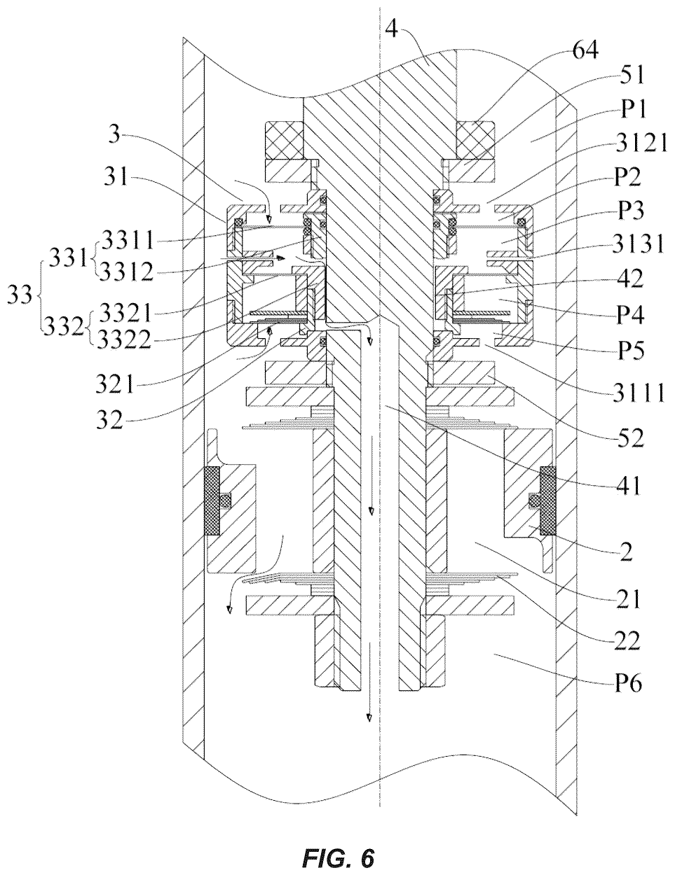

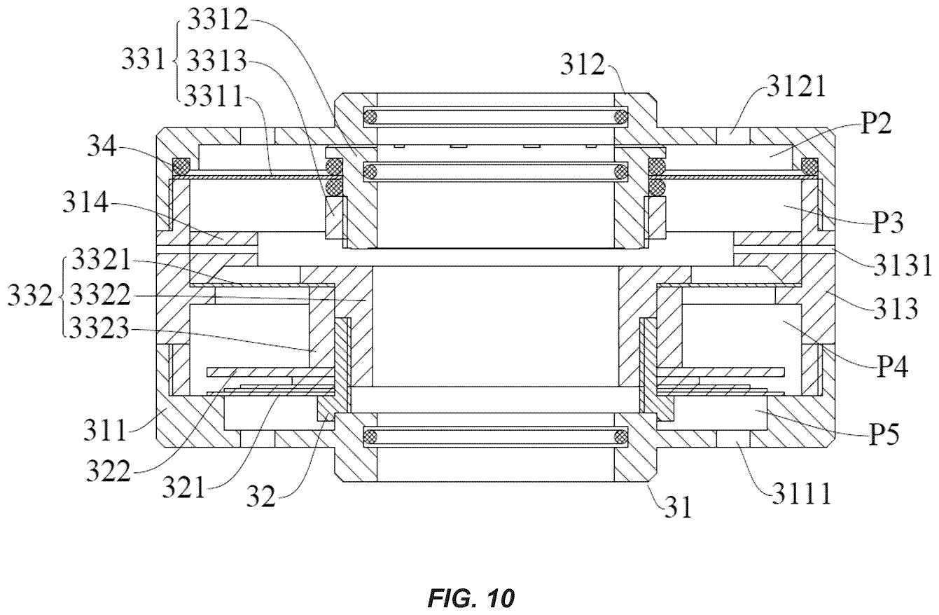

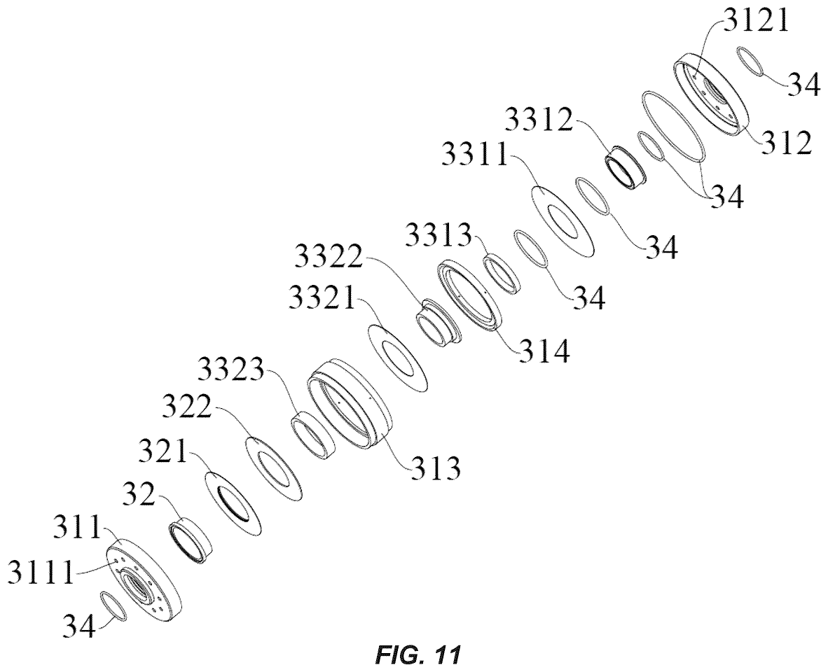

Example embodiments of a hydraulic damper and a vehicle, in accordance with the disclosed technology, are described below with reference to FIG. 1 to FIG. 13.

As shown in FIG. 1 to FIG. 13, the hydraulic damper according to an example embodiment of the disclosed technology includes: a cylinder barrel 1, a piston valve 2, a piston rod 4 and a frequency selection valve.

The piston valve 2 is arranged inside the cylinder barrel 1, and the piston valve 2 divide a chamber of the cylinder barrel 1 into a compression chamber P6 and a recovery chamber P1. The compression chamber P6 and the recovery chamber P1 are filled with oil fluid, and the piston valve 2 is able to slide relative to the cylinder barrel with damping 1. One end of the piston rod 4 (e.g., a lower end of the piston rod as shown in FIG. 1) is threaded through the recovery chamber P1 and coupled with the piston valve 2, and another end of the piston rod 4 (e.g., an upper end of the piston rod as shown in FIG. 1) extends outside the cylinder barrel 1. A bypass flow channel 41 is arranged inside the piston rod 4, and one end of the bypass flow channel 41 is in communication with the compression chamber P6.

The frequency selection valve 3 is arranged inside the recovery chamber P1 and mounted on the piston rod 4. The frequency selection valve 3 is spaced a preset distance from the piston valve 2 along an axial direction of the piston rod 4, and the frequency selection valve 3 is in communication with another end of the bypass flow channel 41. It should be noted that the preset distance can be designed according to a required motion stroke of the hydraulic damper, which is not limited by the disclosed technology.

In a case where an excitation frequency borne by the hydraulic damper is higher than a preset frequency, the frequency selection valve 3 is opened to enable the bypass flow channel 41 to be in communication with the recovery chamber P1. In a case where an excitation frequency borne by the hydraulic damper is lower than the preset frequency, the frequency selection valve 3 is closed to block the bypass flow channel 41 from communicating with the recovery chamber P1.

According to the hydraulic damper of example embodiments of the disclosed technology, during compression and recovery of the hydraulic damper, the piston valve 2 can slide relative to the cylinder barrel with damping 1. When the excitation frequency borne by the hydraulic damper is higher than the preset frequency, the frequency selection valve 3 can be opened to enable the bypass flow channel 41 to be in communication with the recovery chamber P1, thereby reducing a damping force of the piston valve 2 when the piston valve 2 slides to reduce a rigidity of the hydraulic damper. When the excitation frequency borne by the hydraulic damper is lower than the preset frequency, the frequency selection valve 3 can be closed to block the bypass flow channel 41 from communicating with the recovery chamber P1, thereby increasing the damping force of the piston valve 2 when the piston valve 2 slides to improve the rigidity of the hydraulic damper. Therefore, the hydraulic damper of the example embodiments of the disclosed technology can adaptively adjust the damping according to the external excitation frequency and has an improved use effect.

On the other hand, compared to the scheme of setting the frequency selection valve 3 in the compression chamber P6 in related arts, the frequency selection valve 3 of the disclosed technology is mounted in the recovery chamber P1 and not mounted at the end of the piston rod 4. In other words, the frequency selection valve 3 of the hydraulic damper in the embodiment of the present invention can be mounted at any position of the piston rod 4 in the recovery chamber P1, which is conducive to improving the structural strength of the piston rod 4.

It should be noted that piston valve 2 is used to block the recovery chamber P1 from the compression chamber P6. The piston valve 2 includes a damping flow channel 21 and a piston valve plate 22 for opening and closing the damping flow channel 21. When the hydraulic damper is working, the corresponding damping valve plate can be opened to allow oil fluid to flow between the recovery chamber P1 and the compression chamber P6 through the damping flow channel 21, which leads to a greater damping force of the hydraulic damper. The piston valve 2 can also adopt other forms of valve structures in the related arts, which is not limited by the disclosed technology.

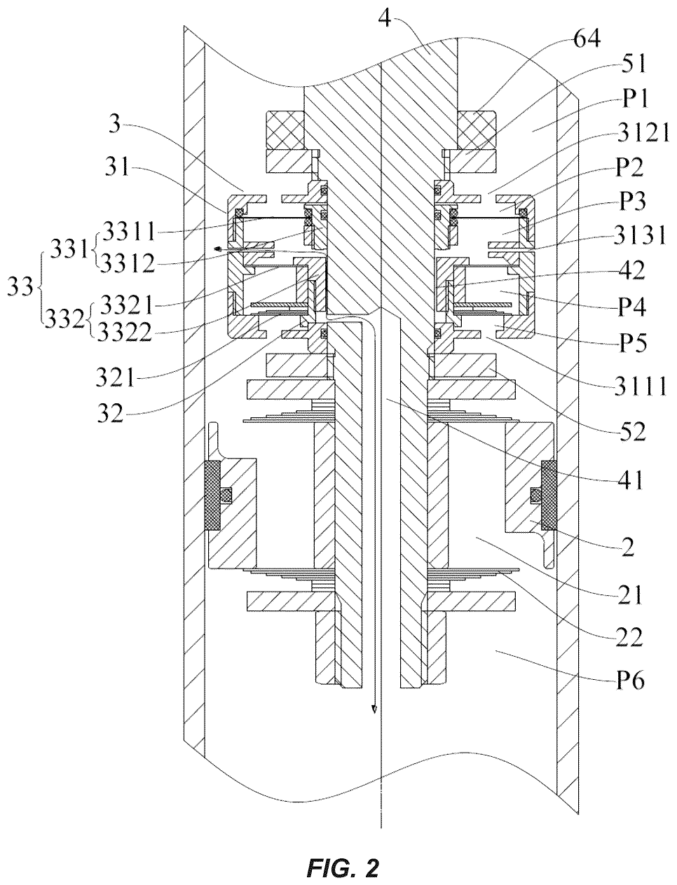

As shown in FIG. 2, the frequency selection valve 3 includes a valve housing 31, a bypass valve 32, and a frequency selection component 33. The valve housing 31 is fixedly sleeved on the piston rod 4, and both the bypass valve 32 and the frequency selection component 33 are mounted inside the valve housing 31. One end of the valve housing 31 close to the piston valve 2 is provided with a first opening 3111, and one end of the valve housing 31 facing away from the piston valve 2 is provided with a second opening 3121. The bypass valve 32 is arranged close to the first opening 3111, the frequency selection component 33 is arranged close to the second opening 3121, and the bypass valve 32 is movable along the axial direction of the piston rod 4. As shown in FIG. 2, the first opening 3111 is provided on a lower end of the valve housing 31 and in communication with the recovery chamber P1. The frequency selection component 33 is arranged at an upper end of the bypass valve 32, and when the frequency selection component 33 moves up and down under pressure, the frequency selection component 33 can synchronously drive the bypass valve 32 to move up and down.

In a working condition that the piston valve 2 moves towards the recovery chamber P1, in a case where the excitation frequency borne by the hydraulic damper is higher than the preset frequency, the frequency selection component 33 drives the bypass valve 32 to be separated from the valve housing 31 to enable the first opening 3111 to be in communication with the bypass flow channel 41. In a case where the excitation frequency borne by the hydraulic damper is lower than the preset frequency, the frequency selection component 33 drives the bypass valve 32 to be in contact with the valve housing 31 to block the bypass flow channel 41 from communicating with the first opening 3111.

It can be understood that at the moment when the hydraulic damper is recovered (i.e., the moment when the piston rod 4 moves away from the compression chamber P6 and gradually extends out of the cylinder 1 barrel), the excitation frequency borne by the hydraulic damper is higher than the preset frequency. At this time, the frequency selection component 33 of the frequency selection valve 3 can drive the bypass valve 32 to move upward to be spaced apart from the valve housing 31, thereby communicating the first opening 3111 with the bypass flow channel 41 and reducing the rigidity of the hydraulic damper.

In a scenario where the hydraulic damper has been recovered for a period of time, the excitation frequency borne by the hydraulic damper is lower than the preset frequency. At this time, the frequency selection component 33 of the frequency selection valve 3 can drive the bypass valve 32 to move downward, to be in contact with the valve housing 31, thereby blocking the first opening 3111 from communicating with the bypass flow channel 41, thereby increasing the rigidity of the hydraulic damper.

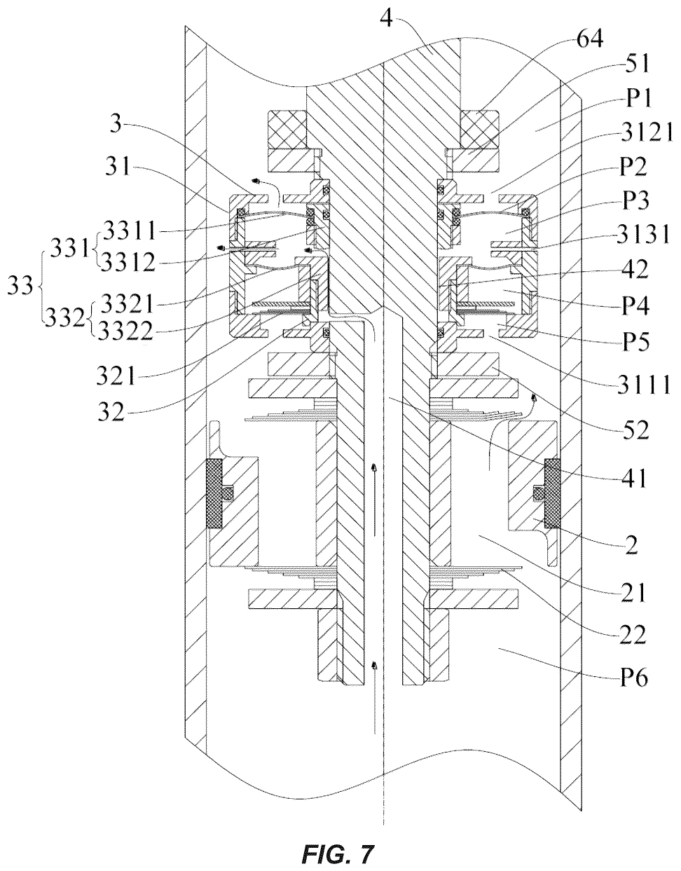

As shown in FIG. 7, in a working condition where the piston valve 2 moves towards compression chamber P6, the bypass valve 32 is in contact with valve housing 31 to block the bypass flow channel 41 from communicating with the first opening 3111. In other words, during a compression process of the hydraulic damper, the bypass valve 32 is in a closed state to maintain a high damping force of the hydraulic damper and improve the use effect of the hydraulic damper.

Specifically, the frequency selection component 33 includes a flexible membrane assembly 331 and a frequency selection membrane assembly 332, and a bypass valve plate 321 is provided on the bypass valve 32. The bypass valve plate 321 and the valve housing 31 define a bypass chamber P5 which is in communication with the first opening 3111, and the flexible membrane assembly 331 and the valve housing 31 define a flexible chamber P2 which is in communication with the second opening 3121. One side of the flexible membrane assembly 331 is fixedly coupled to the valve housing 31, and another side of the flexible membrane assembly 331 is slidably sleeved on the piston rod 4. The frequency selection membrane assembly 332, the valve housing 31, and the flexible membrane assembly 331 jointly define a frequency selection upper chamber P3, and the frequency selection membrane assembly 332, the valve housing 31, and the bypass valve 32 jointly define a frequency selection lower chamber P4. The valve housing 31 is provided with a frequency selection pinhole 3131, and the recovery chamber P1 is in communication with the frequency selection upper chamber P3 through the frequency selection pinhole 3131. One side (a radial outer side) of the frequency selection membrane assembly 332 is coupled to the valve housing 31, another side (an radial inner side) of the frequency selection membrane assembly 332 is slidably sleeved on the piston rod 4 and coupled to the bypass valve 32, an inner wall of the frequency selection membrane assembly 332 and an outer wall of the piston rod 4 define a bypass flow gap 42, and one end of the bypass flow gap 42 is in communication with the bypass flow channel 41.

As shown in FIG. 2, in a direction from top to bottom of the frequency selection valve 3, the second opening 3121, the flexible chamber P2, the frequency selection upper chamber P3, the frequency selection lower chamber P4, the bypass valve 32, and the first opening 3111 are arranged in sequence. The flexible membrane assembly 331 separates the flexible chamber P2 from the frequency selection upper chamber P3, the frequency selection membrane assembly 332 separates the frequency selection upper chamber P3 from the frequency selection lower chamber P4, and the bypass valve plate 321 separates the selection upper chamber P3 from the bypass valve 32.

It should be noted that the frequency selection upper chamber P3 is in communication with the recovery chamber P1 through the frequency selection pinhole 3131 (a slender strip hole). Due to a damping effect of the frequency selection pinhole 3131, there is an instantaneous pressure difference between the frequency selection upper chamber P3 and the recovery chamber P1 during the recovery of the hydraulic damper, and pressure values tend to be equal after a period of time.

In a case where a pressure of the flexible chamber P2 is greater than a pressure of the frequency selection upper chamber P3, the flexible membrane assembly 331 moves towards the frequency selection membrane assembly 332 to block another end of the bypass flow gap 42 from communicating with the frequency selection upper chamber P3. In a case where the pressure of the flexible chamber P2 is less than or equal to the pressure of the frequency selection upper chamber P3, the flexible membrane assembly 331 moves away from the frequency selection membrane assembly 332 to enable the other end of the bypass flow gap 42 to be in communication with the frequency selection upper chamber P3.

In a case where a pressure of the bypass chamber P5 is greater than a pressure in the frequency selection lower chamber P4 and exceeds a preset threshold, the bypass valve plate 321 is elastically deformed to enable the bypass chamber P5 to be in communication with the frequency selection lower chamber P4. In a case where the pressure of the bypass chamber P5 is less than or equal to the preset threshold, the bypass valve plate 321 resets to block the bypass chamber P5 from communicating with the frequency selection lower chamber P4.

In a case where a pressure of the frequency selection lower chamber P4 is greater than the pressure of the frequency selection upper chamber P3, the frequency selection membrane assembly 332 drives the bypass valve 32 to move towards the flexible membrane assembly 331 to enable the first opening 3111 to be in communication with the bypass flow channel 41 and the bypass chamber P5, and to block the other end of the bypass flow gap 42 from communicating with the frequency selection upper chamber P3. In a case where the pressure of the frequency selection lower chamber P4 is less than or equal to the pressure of the frequency selection upper chamber P3, the frequency selection membrane assembly 332 drives the bypass valve 32 to move away from the flexible membrane assembly 331 to block the first opening 3111 from communicating with the bypass flow channel 41 and the bypass chamber P5, and to enable the other end of the bypass flow gap 42 to be in communication with the frequency selection upper chamber P3.

The hydraulic damper of the example embodiments in accordance with the disclosed technology adopts the above-mentioned structural arrangement, so that the bypass valve 32 only opens for a certain period of time after the beginning of the recovery stroke of the piston rod 4, and closes after a certain flow of the oil fluid circulated, and the above flow requires pressure difference and time. During a low-frequency excitation process of the hydraulic damper, the frequency selection upper chamber P3 can reach equilibrium pressure before the recovery process is completed, so as to reset the frequency selection membrane assembly 332 and close the bypass valve 32, thereby causing the hydraulic damper to produce a rigid damping during the remaining recovery process.

When the hydraulic damper is under a high-frequency excitation, the frequency selection upper chamber P3 is still insufficient to reach equilibrium within a complete recovery process, which can ensure that the bypass valve 32 remains consistently open during the high-frequency excitation, thereby reducing the rigidity of the hydraulic damper.

As shown in FIG. 2, when the hydraulic damper of the embodiment of the present invention is in a stationary state, the pressures of the recovery chamber P1, the flexible chamber P2, the frequency selection upper chamber P3, the frequency selection lower chamber P4, the bypass chamber P5, and the compression chamber P6 are equal. The flexible membrane assembly 331 is at a top dead center (i.e., a limit position of upward movement of the flexible membrane assembly 331), and the frequency selection membrane assembly 332 is at a bottom dead center (i.e., a limit position of downward movement of the frequency selection membrane assembly 332). At this time, the recovery chamber P1 is in communication with the compression chamber P6 through the frequency selection pinhole 3131, the frequency selection lower chamber P4, the bypass flow gap 42, and the bypass flow channel 41.

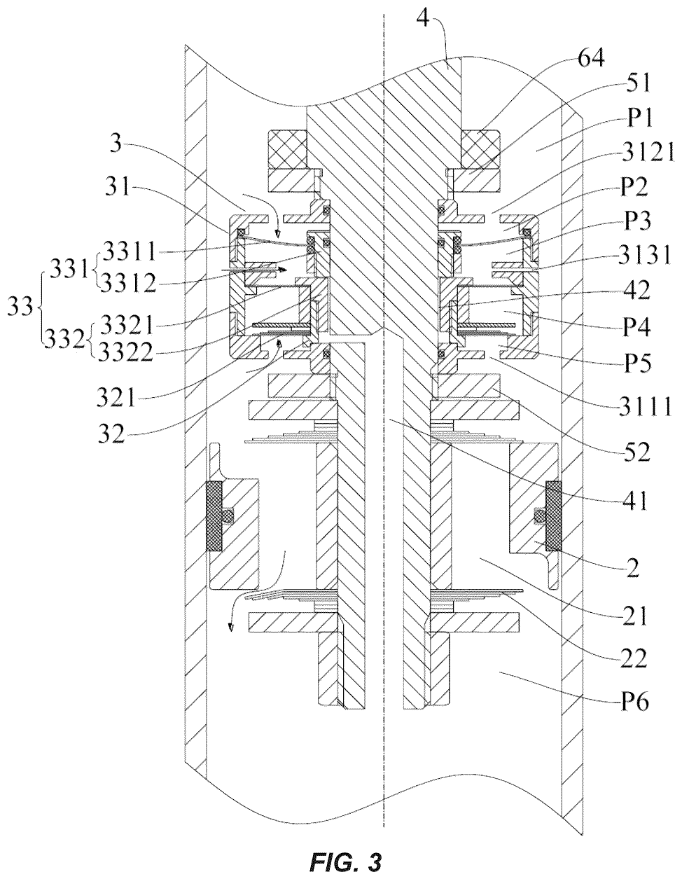

As shown in FIG. 3 to 6, the recovery process of the hydraulic damper of example embodiments in accordance with the disclosed technology is described in detail. According to a time order of the recovery, the recovery process of the hydraulic damper can be divided into a first stage, a second stage, a third stage, and a fourth stage.

At the first stage:

The piston rod 4 moves in a recovery direction (from down to up in FIG. 1), and at this time, the pressure of the recovery chamber P1 is greater than the pressure in the compression chamber P6. The oil fluid in the recovery chamber P1 flows into the compression chamber P6 through the piston valve 2, generating a large damping force.

The flexible chamber P2 is in communication with the recovery chamber P1, and the pressure of the recovery chamber P1 is equal to the pressure of the flexible chamber P2. The frequency selection chamber P3 is in communication with the recovery chamber P1 through the frequency selection pinhole 3131. Due to a small gap of the frequency selection pinhole 3131, there is a delay in the pressure change. In an instant, the pressure of the recovery chamber P1 is greater than the pressure of the frequency selection chamber P3, and then the pressure of the flexible chamber P2 is greater than the pressure of the frequency selection chamber P3.

The flexible membrane assembly 331 moves downwards from the top dead center to come into contact with the frequency selection membrane assembly 332, closing the communication between the frequency selection upper chamber P3 and the bypass flow gap 42, and continuing to push the frequency selection membrane assembly 332 downwards, closing the bypass valve 32, blocking the communication between the bypass chamber P5 and the bypass flow channel 41, while providing an instantaneous contact pressure to the bypass valve plate 321, blocking the communication between the bypass chamber P5 and the frequency selection lower chamber P4, so that in an instant, the pressure of the bypass chamber P5 is greater than the pressure of the frequency selection lower chamber P4.

At the second stage:

Due to the pressure of the bypass chamber P5 being greater than the pressure of the frequency selection lower chamber P4, in responding to reaching the threshold, the bypass valve plate 321 opens. The oil fluid enters the frequency selection lower chamber P4 from the bypass chamber P5, and after a short period of time, the pressure of the frequency selection lower chamber P4 is equal to the pressure of the bypass chamber P5.

At the third stage:

Due to the recovery chamber P1 being in communication with the bypass chamber P5, the pressure of the recovery chamber P1 is equal to the pressure of the bypass chamber P5. Additionally, since the pressure of the frequency selection lower chamber P4 is equal to the pressure of the bypass chamber P5, the pressure of the recovery chamber P1 is equal to the pressure of the frequency selection lower chamber P4.

Due to a delay of the oil fluid entering the frequency selection upper chamber P3 through the frequency selection pinhole 3131, in an instant, the pressure of the recovery chamber P1 is greater than the pressure of the frequency selection upper chamber P3. Therefore, the pressure of the frequency selection lower chamber P4 is greater than the pressure of the frequency selection upper chamber P3.

Due to the pressure of the frequency selection lower chamber P4 being greater than the pressure of the frequency selection upper chamber P3, the frequency selection membrane assembly 332 moves towards the frequency selection upper chamber P3, driving the bypass valve 32 to move upward and open the bypass valve 32. At this time, the bypass chamber P5 is in communication with the bypass flow channel 41, and a large amount of oil fluid in the recovery chamber P1 flows directly into the compression chamber P6 through the bypass chamber P5 and the bypass flow channel 41, reducing the flow of oil fluid through the piston valve 2 and greatly reducing the damping force of the hydraulic damper.

At the fourth stage:

After the hydraulic damper is recovered for a period of time, the oil fluid completely enters the frequency selection upper chamber P3, so that the pressure of the recovery chamber P1 is equal to the pressure of the frequency selection upper chamber P3, so the pressure of the flexible chamber P2=the pressure of the frequency selection upper chamber P3=the pressure of the frequency selection lower chamber P4.

Due to the fact that the pressure of the flexible chamber P2=the pressure of the frequency selection upper chamber P3=the pressure of the frequency selection lower chamber P4, the flexible membrane assembly 331 and the frequency selection membrane assembly 332 do not move, and the flexible membrane assembly 331 is arranged at the top dead center, and the bypass flow gap 42 is opened. The frequency selection membrane assembly 332 is arranged at the bottom dead center, the bypass valve 32 is closed.

The recovery chamber P1 is in communication with the compression chamber P6 through the frequency selection pinhole 3131, the frequency selection upper chamber P3, the bypass flow gap 42, and the bypass flow channel 41. Due to a low flow of the frequency selection pinhole 3131, there is only a small amount of oil fluid flowing from the recovery chamber P1 into the compression chamber P6 through the frequency selection pinhole 3131, the bypass flow gap 42, and the bypass flow channel 41. There is still a large amount of oil fluid passing through the piston valve 2 to maintain a high damping force of the hydraulic damper.

As shown in FIG. 7, the compression process of the hydraulic damper in the example embodiment of the disclosed technology is described in detail.

The piston rod 4 moves in the compression direction (a direction from up to down in FIG. 7), and at this time, the pressure of the compression chamber P6 is greater than the pressure of the recovery chamber P1. The oil fluid in the compression chamber P6 flows into the recovery chamber P1 through the piston valve 2, generating a large damping force.

The frequency selection upper chamber P3 is in communication with the compression chamber P6 through the bypass flow gap 42 and the bypass flow channel 41, and the pressure of the frequency selection upper chamber P3 is equal to the pressure of the compression chamber P6.

Because the flexible chamber P2 and the bypass chamber P5 are in communication with the recovery chamber P1, and the pressure of the recovery chamber P1=the pressure of the flexible chamber P2=the pressure of the frequency selection lower chamber P4=the pressure of the bypass chamber P5, the pressure of the flexible chamber P2=the pressure of the frequency selection lower chamber P4<the pressure of the frequency selection upper chamber P3. Therefore, the flexible membrane assembly 331 is arranged at the top dead center and the bypass flow gap 42 is opened. The frequency selection membrane assembly 332 is arranged at the bottom dead center, and the bypass valve 32 is closed.

At this time, the compression chamber P6 is in communication with the recovery chamber P1 through the bypass flow channel 41, the bypass flow gap 42, and the frequency selection upper chamber P3. Due to the low flow of the frequency selection pinhole 3131, there is only a small amount of oil fluid flowing from the compression chamber P6 into the recovery chamber P1 through the bypass flow gap 42, the bypass flow channel 41 and the frequency selection upper chamber P3. There is still a large amount of oil fluid passing through the piston valve 2 to maintain a high damping force of the hydraulic damper.

In some embodiments, the flexible membrane assembly 331 includes a flexible membrane 3311 and a flexible membrane slide seat 3312. One side (a radial outer side) of the flexible membrane 3311 is coupled to the valve housing 31, and another side (an inner side) of the flexible membrane 3311 is coupled to the flexible membrane slide seat 3312. The flexible membrane slide seat 3312 is slidably sleeved on the piston rod 4. In a case where the pressure of the flexible chamber P2 is greater than THE pressure of the frequency selection upper chamber P3, the flexible membrane 3311 is elastically deformed to move the flexible membrane slide seat 3312 towards the frequency selection membrane assembly 332, and in a case where the pressure of the flexible chamber P2 is less than or equal to the pressure of the frequency selection upper chamber P3, the flexible membrane 3311 is reset to move the flexible membrane slide seat 3312 away from the frequency selection membrane assembly 332.

It can be understood that when the flexible membrane 3311 deforms, the one side of the flexible membrane 3311 can remain stationary with the valve housing 31, while the other side of the flexible membrane 3311 bends downward to deform, causing the flexible membrane slide seat 3312 to move downward from a top dead center to a bottom dead center. According to the example embodiments of the disclosed technology, the flexible membrane assembly 331 of the hydraulic damper is provided with the above structure, which can make processing and manufacturing of the flexible membrane assembly 331 simple and a motion process reliable.

Furthermore, the frequency selection valve 3 further includes a limiting plate 322, and both the limiting plate 322 and the bypass valve plate 321 are sleeved on the bypass valve 32. The limiting plate 322 is arranged on a side of the bypass valve plate 321 facing away from the first opening 3111, and a radial outer side of the limiting plate 322 is spaced a predetermined distance from a radial outer side of the bypass valve plate 321 along the axial direction of the piston rod 4. It can be understood that the limiting plate 322 is arranged above the bypass valve plate 321. Therefore, when the bypass valve plate 321 bends and deforms, the bypass valve plate 321 can be stopped by the limiting plate 322 to avoid excessive deformation of the bypass valve plate 321, which is conducive to ensuring an operation reliability of the bypass valve plate 321.

Optionally, the frequency selection membrane assembly 332 includes a frequency selection membrane 3321 and a frequency selection membrane slide seat 3322. One side (a radial outer side) of the frequency selection membrane 3321 is coupled to the valve housing 31, and another side (an inner side) of the frequency selection membrane 3321 is coupled to the frequency selection membrane slide seat 3322. The frequency selection membrane slide seat 3322 is slidably sleeved on the piston rod 4 and defines the bypass flow gap 42 with the piston rod 4. The frequency selection membrane slide seat 3322 is coupled to the bypass valve 32. In a case where the pressure of the frequency selection lower chamber P4 is greater than the pressure of the frequency selection upper chamber P3, the frequency selection membrane 3321 is elastically deformed to move the frequency selection membrane slide seat 3322 and the bypass valve 32 towards the flexible membrane assembly 331. In a case where the pressure of the frequency selection lower chamber P4 is less than or equal to the pressure of the frequency selection upper chamber P3, the frequency selection membrane 3321 is reset to move the frequency selection membrane slide seat 3322 and the bypass valve 32 away from the flexible membrane 3311.

It can be understood that when the frequency selection membrane 3321 deforms, the one side of the frequency selection membrane 3321 can remain stationary with the valve housing 31, while the other side of the frequency selection membrane 3321 bends upward and deforms, causing the frequency selection membrane slide seat 3322 to move upward from a bottom dead center to a top dead center. According to the example embodiments of the disclosed technology, the frequency selection membrane assembly 332 of the hydraulic damper is provided with the above structure, which can make processing and manufacturing of the frequency selection membrane assembly 332 simple and a motion process reliable.

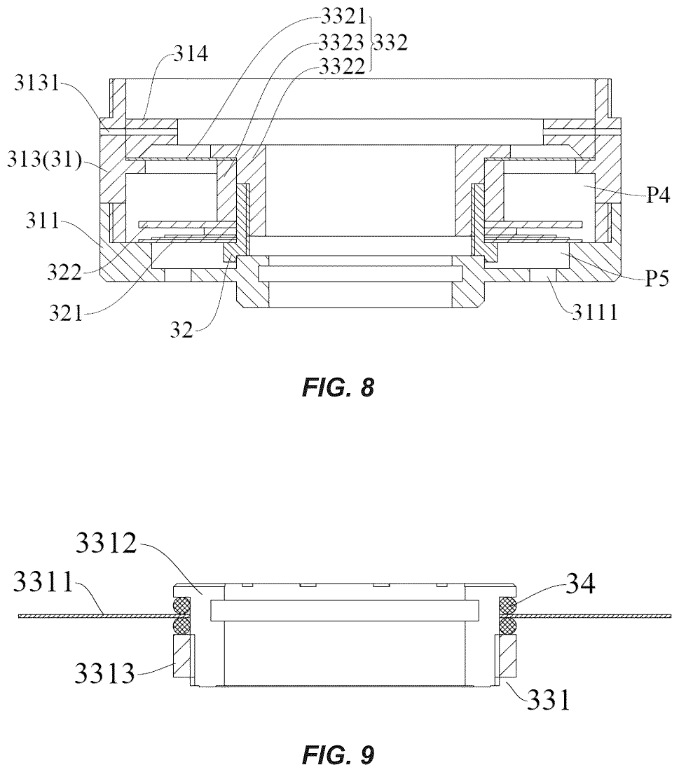

In some embodiments, as shown in FIG. 8 to FIG. 10, the valve housing 31 includes a valve housing body 313, an upper valve cover 312, a lower valve cover 311, and a frequency selection pinhole seat 314. The upper valve cover 312 and the lower valve cover 311 are respectively mounted at two ends of the valve housing body 313 along the axial direction of the piston rod 4. The first opening 3111 is provided on the lower valve cover 311, and the second opening 3121 is provided on the upper valve cover 312. The frequency selection pinhole seat 314 is detachably mounted inside the valve housing body 313, an extension direction of the frequency selection pinhole 3131 is perpendicular to the axial direction of the piston rod 4, a part of the frequency selection pinhole 3131 is formed on the valve housing body 313, and another part of the frequency selection pinhole 3131 is formed on the frequency selection pinhole seat 314.

It can be understood that the upper valve cover 312 is detachably mounted at an upper end of the valve housing body 313, and the lower valve cover 311 is detachably mounted at a lower end of the valve housing body 313. Due to the frequency selection pinhole seat 314 is detachably mounted inside the valve housing body 313, the extension direction of the frequency selection pinhole 3131 is perpendicular to the axial direction of the piston rod 4. A part of the frequency selection pinhole 3131 is formed on the valve housing body 313, while another part of the frequency selection pinhole 3131 is formed on the frequency selection pinhole seat 314. This not only facilitates an assembly of the valve housing 31 but also extends a flow path of the frequency selection pinhole 3131. For example, there can be two frequency selection pinholes 3131, which extend along a radial direction of the valve housing 31 and are symmetrically arranged on two sides of the valve housing 31.

Specially, the upper valve cover 312 and the valve housing body 313 define a first clamping groove, and one side of the flexible membrane 3311 is fixed in the first clamping groove. The flexible membrane assembly 331 further includes a locking ring 3313, and the locking ring 3313 is sleeved outside the flexible membrane slide seat 3312 and defines a second clamping groove with the flexible membrane slide seat 3312. Another side of the flexible membrane 3311 is fixed in the second clamping groove. It can be understood that when the upper valve cover 312 is assembled with the valve housing body 313, the radial outer side of the flexible membrane 3311 can be compressed and clamped, and the locking ring 3313 is coupled to the flexible membrane slide seat 3312 and compresses the radial inner side of the flexible membrane 3311.

For example, a sealing ring 34 can be provided at an upper and lower connection position of the flexible membrane 3311, which, on the one hand, can seal the flexible chamber P2 and provide a certain elastic preload force, on the other hand, can avoid hard contact between the flexible membrane 3311 with the upper valve cover 312 and the valve housing body 313, thereby extending a service life of the flexible membrane 3311. Furthermore, a sealing ring 34 can also be provided between the upper valve cover 312 and the piston rod 4, as well as between the lower valve cover 311 and the piston rod 4, to improve a sealing effect of the frequency selection valve 3.

When the frequency selection pinhole seat 314 is mounted with the valve housing body 313, the frequency selection pinhole seat 314 can clamp and fix the radial outer side of the frequency selection membrane 3321. The frequency selection membrane assembly 332 also includes a supporting ring 3323. An upper end surface of the supporting ring 3323 is in contact with the frequency selection membrane slide seat 3322 and clamps the radial inner side of the frequency selection membrane 3321. The lower end surface of the supporting ring 3323 is in contact with the limiting plate 322 to axially limit the limiting plate 322.

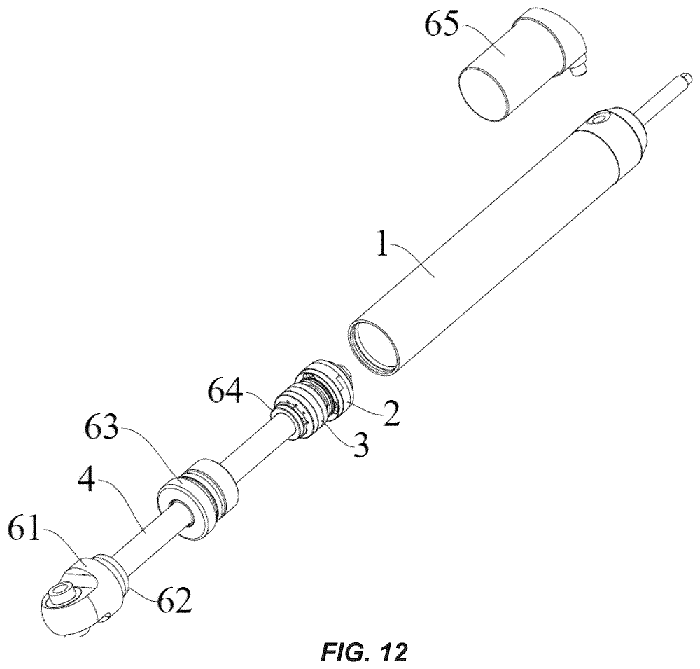

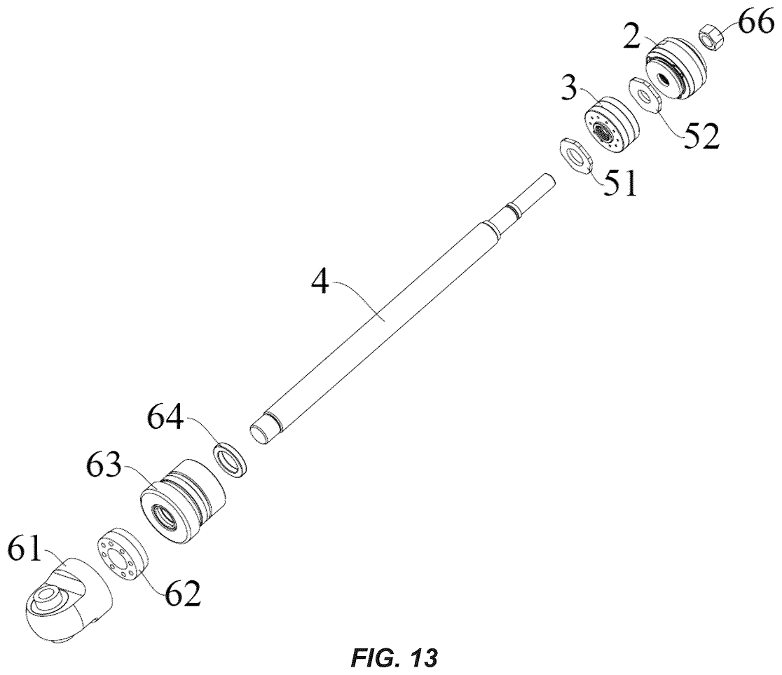

As shown in FIG. 13, as shown in FIG. 12 and FIG. 13, the hydraulic damper further includes a first limiting nut 51 and a second limiting nut 52. The first limiting nut 51 and the second limiting nut 52 are arranged respectively on two sides of the frequency selection valve 3 along the axial direction of the piston rod 4, and the first limit nut 51 and the second limit nut 52 are threaded with the piston rod 4 and clamp the frequency selection valve 3, which can achieve the axial limiting of the frequency selection valve 3, and easy to mount and disassemble.

Specifically, as shown in FIG. 12 and FIG. 13, the hydraulic damper further includes a connecting seat 61, an outer buffer block 62, a front end cover 63, and an inner buffer block 64. The connecting seat 61 is mounted on the upper end of the piston rod 4, the outer buffer block 62 is sleeved on the piston rod 4 and arranged close to the connecting seat 61, the front end cover 63 is mounted on the cylinder barrel 1 to block the recovery chamber P1, and the inner buffer block 64 is sleeved on the piston rod 4 and arranged close to the frequency selection valve 3. A lower end of the piston valve 2 is equipped with a fixed nut 66, which is threaded with the piston rod 4 to limit an axial position of the piston valve 2.

In other examples, as shown in FIG. 1, the hydraulic damper also includes a nitrogen cylinder assembly 65, which is mounted outside the cylinder barrel 1 and in communication with the compression chamber P6 to provide the piston rod 4 with a restoring force and suppress vaporization of the oil fluid, thereby improving the damping effect of the hydraulic damper.

The following describes the recovery process of a hydraulic damper according to an example embodiment of the disclosed technology.

The recovery process of the hydraulic damper is divided into a first stage, a second stage, a third stage, and a fourth stage.

At the first stage:

The piston rod 4 moves in a recovery direction (from down to up in FIG. 1), and at this time, the pressure of the recovery chamber P1 is greater than the pressure in the compression chamber P6. The oil fluid in the recovery chamber P1 flows into the compression chamber P6 through the piston valve 2, generating a large damping force.

The flexible chamber P2 is in communication with the recovery chamber P1, and the pressure of the recovery chamber P1 is equal to the pressure of the flexible chamber P2. The frequency selection chamber P3 is in communication with the recovery chamber P1 through the frequency selection pinhole 3131. Due to a small gap of the frequency selection pinhole 3131, there is a delay in the pressure change. In an instant, the pressure of the recovery chamber P1 is greater than the pressure of the frequency selection chamber P3, and then the pressure of the flexible chamber P2 is greater than the pressure of the frequency selection chamber P3. The flexible membrane 3311 bends and deforms towards the frequency selection upper chamber P3, driving the flexible membrane slide seat 3312 to move from a top dead center to contact with the frequency selection membrane slide seat 3322, closing the communication between the frequency selection upper chamber P3 and the bypass flow gap 42, and continuing to push the frequency selection membrane slide seat 3322 downwards, closing the bypass valve 32, blocking the communication between the bypass chamber P5 and the bypass flow channel 41, and providing an instantaneous contact pressure to the bypass valve plate 321, blocking the communication between the bypass chamber P5 and the frequency selection lower chamber P4, so that in an instant, the pressure of the bypass chamber P5 is greater than the pressure of the frequency selection lower chamber P4.

At the second stage:

Due to the pressure of the bypass chamber P5 being greater than the pressure of the frequency selection lower chamber P4, in responding to reaching the threshold, the bypass valve plate 321 opens. The oil fluid enters the frequency selection lower chamber P4 from the bypass chamber P5, and after a short period of time, the pressure of the frequency selection lower chamber P4 is equal to the pressure of the bypass chamber P5.

At the third stage:

Due to the recovery chamber P1 being in communication with the bypass chamber P5, the pressure of the recovery chamber P1 is equal to the pressure of the bypass chamber P5. Additionally, since the pressure of the frequency selection lower chamber P4 is equal to the pressure of the bypass chamber P5, the pressure of the recovery chamber P1 is equal to the pressure of the frequency selection lower chamber P4.

Due to a delay of the oil fluid entering the frequency selection upper chamber P3 through the frequency selection pinhole 3131, in an instant, the pressure of the recovery chamber P1 is greater than the pressure of the frequency selection upper chamber P3. Therefore, the pressure of the frequency selection lower chamber P4 is greater than the pressure of the frequency selection upper chamber P3.

Due to the pressure of the frequency selection lower chamber P4 being greater than the pressure of the frequency selection upper chamber P3, the frequency selection membrane 3321 bends and deforms towards the frequency selection upper chamber P3, driving the frequency selection membrane slide seat 3322 to move upward and open the bypass valve 32. The bypass chamber P5 is in communication with the bypass flow channel 41, and a large amount of oil fluid in the recovery chamber P1 flows directly into the compression chamber P6 through the bypass chamber P5 and the bypass flow channel 41, reducing the flow of oil fluid through the piston valve 2 and greatly reducing the damping force of the hydraulic damper.

At the fourth stage:

After the hydraulic damper is recovered for a period of time, the oil fluid completely enters the frequency selection upper chamber P3, so that the pressure of the recovery chamber P1 is equal to the pressure of the frequency selection upper chamber P3, so the pressure of the flexible chamber P2=the pressure of the frequency selection upper chamber P3=the pressure of the frequency selection lower chamber P4.

Due to the fact that the pressure of the flexible chamber P2=the pressure of the frequency selection upper chamber P3=the pressure of the frequency selection lower chamber P4, the flexible membrane 3311 and the frequency selection membrane 3321 do not bend and deform, and the flexible membrane slide seat 3312 is arranged at the top dead center, and the bypass flow gap 42 is opened. The frequency selection membrane slide seat 3322 is arranged at the bottom dead center, the bypass valve 32 is closed.

The recovery chamber P1 is in communication with the compression chamber P6 through the frequency selection pinhole 3131, the frequency selection upper chamber P3, the bypass flow gap 42, and the bypass flow channel 41. Due to a low flow of the frequency selection pinhole 3131, there is only a small amount of oil fluid flowing from the recovery chamber P1 into the compression chamber P6 through the frequency selection pinhole 3131, the bypass flow gap 42, and the bypass flow channel 41. There is still a large amount of oil fluid passing through the piston valve 2 to maintain a high damping force of the hydraulic damper.

From this, it can be inferred that bypass valve 32 only opens at the beginning of the recovery stroke and closes after a certain flow. This kind of flow requires pressure difference and time. During the low-frequency excitation process of the hydraulic damper, the frequency selection upper chamber P3 can reach an equilibrium pressure before the end of the recovery process, causing the frequency selection membrane slide seat 3322 to return and the bypass valve 32 to close, thereby generating a strong damping force during the remaining recovery process. During the high-frequency excitation, the frequency selection upper chamber P3 is still insufficient to reach equilibrium within a complete recovery process, causing the bypass valve 32 to remain open during the high-frequency excitation, thereby reducing the rigidity of the hydraulic damper.

As shown in FIG. 7, the compression process of a hydraulic damper according to an example embodiment of the disclosed technology is described in detail.

The piston rod 4 moves in the compression direction (a direction from up to down in FIG. 7), and at this time, the pressure of the compression chamber P6 is greater than the pressure of the recovery chamber P1. The oil fluid in the compression chamber P6 flows into the recovery chamber P1 through the piston valve 2, generating a large damping force. The frequency selection upper chamber P3 is in communication with the compression chamber P6 through the bypass flow gap 42 and the bypass flow channel 41, and the pressure of the frequency selection upper chamber P3 is equal to the pressure of the compression chamber P6.

Because the flexible chamber P2 and the bypass chamber P5 are in communication with the recovery chamber P1, and the pressure of the recovery chamber P1=the pressure of the flexible chamber P2=the pressure of the frequency selection lower chamber P4=the pressure of the bypass chamber P5, the pressure of the flexible chamber P2=the pressure of the frequency selection lower chamber P4<the pressure of the frequency selection upper chamber P3. Therefore, the flexible membrane 3311 bends and deforms towards the flexible chamber P2, causing the flexible membrane slide seat 3312 to be arranged at the top dead center, and to open the bypass flow gap 42. The frequency selection membrane 3321 bends and deforms towards the frequency selection lower chamber P4, causing the frequency selection membrane slide seat 3322 to be arranged at the bottom dead center, and to close the bypass valve 32.

At this time, the compression chamber P6 is in communication with the recovery chamber P1 through the bypass flow channel 41, the bypass flow gap 42, and the frequency selection upper chamber P3. Due to the low flow of the frequency selection pinhole 3131, there is only a small amount of oil fluid flowing from the compression chamber P6 into the recovery chamber P1 through the bypass flow gap 42, the bypass flow channel 41 and the frequency selection upper chamber P3. There is still a large amount of oil fluid passing through the piston valve 2 to maintain a high damping force of the hydraulic damper.

A vehicle according to some example embodiments in accordance with the disclosed technology includes the hydraulic damper of example embodiments of the disclosed technology. The technical advantages of the vehicle include at least the same as those of the hydraulic damper in the above example embodiments.

### CONCLUSION

In this disclosure, it should be understood that orientations or position relationships indicated by terms “central,” “longitudinal,” “transverse,” “length,” “width,” “thickness,” “upper,” “lower,” “front,” “rear,” “left,” “right,” “vertical,” “horizontal,” “top,” “bottom,” “inner,” “outer,” “clockwise,” “counterclockwise,” “axial,” “radial,” “circumferential,” etc. are based on the orientations or position relationships illustrated in the accompanying drawings, and are only for convenience of describing the disclosure and simplifying the description, rather than indicating or implying that devices or components referred to must have a particular orientation, be constructed and operated in the particular orientation.

In addition, terms “first” and “second” are only used to describe the purpose and cannot be understood as indicating or implying relative importance or implying the quantity of technical features indicated. Therefore, features limited to “first” and “second” may explicitly or implicitly include at least one of these features. In the description disclosed herein, “a plurality of” means at least two, such as two, three, etc., unless otherwise specified with specific limitations.

In this disclosure, unless otherwise specified and limited, terms “mount,” “couple,” “connect,” “fix,” and other terms should be broadly understood. For example, they may be a fixed connection, a detachable connection, or integrated. They may also be a mechanical connection, an electrical connection or communication with each other. They may be directly coupled or indirectly coupled through an intermediate medium. They may be an internal connection of two components or an interaction relationship between two components, unless otherwise specified. For ordinary those skilled in the art, specific meanings of the above terms in the disclosure may be understood based on specific cases.

In this disclosure, unless otherwise specified and limited, the first feature is “above” or “below” the second feature, which means that the first feature may be in direct contact with the second features, or the first feature may be in indirect contact with the second features through an intermediate media. Moreover, if the first feature is “on,” “above” and “on top of” the second feature, which means that the first feature is directly or diagonally above the second feature, or simply indicates that the first feature is horizontally higher than the second feature. The first feature is “under,” “below,” and “on bottom of” the second feature, which means that the first feature is directly or diagonally below the second feature, or simply indicates that the horizontal height of the first feature is less than that of the second feature.

In this disclosure, terms “an embodiment,” “some embodiments,” “an example,” “a specific examples,” or “some examples” means that a specific feature, structure, material, or characteristic described in connection with embodiments or examples is included in at least one embodiment or example of the disclosed technology. In this specification, the illustrative expressions of the above terms do not necessarily refer to the same embodiments or examples. Moreover, the specific feature, structure, material, or characteristic described may be combined in any suitable manner in one or more embodiments or examples. In addition, those skilled in the art may connect and combine different embodiments or examples as well as features of different embodiments or examples described in this specification, without conflicting with each other.

Although embodiments of the disclosed technology have been shown and described above, it can be understood that the above embodiments are illustrative and cannot be understood as a limitation of the disclosed technology. Those ordinary skilled in the art can make changes, modifications, alternatives, and variations to the above embodiments within the scope of the disclosed technology.

Implementations of the subject matter and the functional operations described in this patent document can be implemented in various systems, digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of nonvolatile memory, media and memory devices, including by way of example semiconductor memory devices, e.g., EPROM, EEPROM, and flash memory devices. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described, and other implementations, enhancements and variations can be made based on what is described and illustrated in this patent document.

What is claimed is:

1. A hydraulic damper, comprising:
a cylinder barrel;
a piston valve, arranged inside the cylinder barrel and slidable relative to the cylinder barrel with damping, and dividing a chamber of the cylinder barrel into a compression chamber and a recovery chamber, wherein the compression chamber and the recovery chamber are filled with oil fluid;
a piston rod, having a first end threaded through the recovery chamber and coupled with the piston valve, and a second end extending outside the cylinder barrel, wherein a bypass flow channel having a first end and a second end is arranged inside the piston rod, and the first end of the bypass flow channel is in communication with the compression chamber; and
a frequency selection valve, arranged inside the recovery chamber, arranged on the piston rod and spaced a preset distance from the piston valve along an axial direction of the piston rod, wherein the frequency selection valve is in communication with the second end of the bypass flow channel;
wherein in a case where an excitation frequency borne by the hydraulic damper is higher than a preset frequency, the frequency selection valve is opened to enable the bypass flow channel to be in communication with the recovery chamber; and
in a case where an excitation frequency borne by the hydraulic damper is lower than the preset frequency, the frequency selection valve is closed to block the bypass flow channel from communicating with the recovery chamber.

2. The hydraulic damper of claim 1, wherein the frequency selection valve comprises:
a valve housing fixedly sleeved on the piston rod, having a first end close to the piston valve and a second end away from the piston valve, wherein the first end of the valve housing is provided with a first opening, and the second end of the valve housing is provided with a second opening;
a bypass valve arranged inside the valve housing and close to the first opening, wherein the bypass valve is movable along the axial direction of the piston rod; and
a frequency selection component arranged inside the valve housing and close to the second opening,
wherein in a working condition that the piston valve moves towards the recovery chamber, in a case where the excitation frequency borne by the hydraulic damper is higher than the preset frequency, the frequency selection component drives the bypass valve to be separated from the valve housing to enable the first opening to be in communication with the bypass flow channel, and in a case where the excitation frequency borne by the hydraulic damper is lower than the preset frequency, the frequency selection component drives the bypass valve to be in contact with the valve housing to block the bypass flow channel from communicating with the first opening; and
wherein in a working condition that the piston valve moves towards the compression chamber, the bypass valve is in contact with the valve housing to block the bypass flow channel from communicating with the first opening.

3. The hydraulic damper of claim 2, wherein the frequency selection component comprises:
a flexible membrane assembly having a first side and a second side, wherein the first side of the flexible membrane assembly is fixedly coupled to the valve housing, and the second side of the flexible membrane assembly is slidably sleeved on the piston rod; and
a frequency selection membrane assembly having a first side and a second side, wherein the first side of the frequency selection membrane assembly is coupled to the valve housing, and the second side of the frequency selection membrane assembly is slidably sleeved on the piston rod and coupled to the bypass valve, wherein a bypass flow gap having a first end and a second end is defined between an inner wall of the frequency selection membrane assembly and an outer wall of the piston rod, and the first end of the bypass flow gap is in communication with the bypass flow channel;
wherein a bypass valve plate is provided on the bypass valve, a bypass chamber in communication with the first opening is defined between the bypass valve plate and the valve housing, and a flexible chamber in communication with the second opening is defined between the flexible membrane assembly and the valve housing;
wherein the frequency selection membrane assembly, the valve housing, and the flexible membrane assembly jointly define a frequency selection upper chamber, and the frequency selection membrane assembly, the valve housing, and the bypass valve jointly define a frequency selection lower chamber, wherein the valve housing is provided with a frequency selection pinhole, and the recovery chamber is in communication with the frequency selection upper chamber through the frequency selection pinhole,
wherein in a case where a pressure of the flexible chamber is greater than a pressure of the frequency selection upper chamber, the flexible membrane assembly moves towards the frequency selection membrane assembly to block the second end of the bypass flow gap from communicating with the frequency selection upper chamber, and in a case where the pressure of the flexible chamber is less than or equal to the pressure of the frequency selection upper chamber, the flexible membrane assembly moves away from the frequency selection membrane assembly to enable the second end of the bypass flow gap to be in communication with the frequency selection upper chamber;
wherein in a case where a pressure of the bypass chamber is greater than a pressure in the frequency selection lower chamber and exceeds a preset threshold, the bypass valve plate is elastically deformed to enable the bypass chamber to be in communication with the frequency selection lower chamber, and in a case where the pressure of the bypass chamber is less than or equal to the preset threshold, the bypass valve plate is reset to block the bypass chamber from communicating with the frequency selection lower chamber; and
wherein in a case where a pressure of the frequency selection lower chamber is greater than the pressure of the frequency selection upper chamber, the frequency selection membrane assembly drives the bypass valve to move towards the flexible membrane assembly to enable the first opening to be in communication with the bypass flow channel and the bypass chamber, and to block the second end of the bypass flow gap from communicating with the frequency selection upper chamber, and in a case where the pressure of the frequency selection lower chamber is less than or equal to the pressure of the frequency selection upper chamber, the frequency selection membrane assembly drives the bypass valve to move away from the flexible membrane assembly to block the first opening from communicating with the bypass flow channel and the bypass chamber, and to enable the second end of the bypass flow gap to be in communication with the frequency selection upper chamber.

4. The hydraulic damper of claim 3, wherein the flexible membrane assembly comprises:
a flexible membrane having a first side and a second side; and
a flexible membrane slide seat slidably sleeved on the piston rod;
wherein the first side of the flexible membrane is coupled to the valve housing, and the second side of the flexible membrane is coupled to the flexible membrane slide seat;
wherein in a case where the pressure of the flexible chamber is greater than the pressure of the frequency selection upper chamber, the flexible membrane is elastically deformed to move the flexible membrane slide seat towards the frequency selection membrane assembly, and in a case where the pressure of the flexible chamber is less than or equal to the pressure of the frequency selection upper chamber, the flexible membrane is reset to move the flexible membrane slide seat away from the frequency selection membrane assembly.

5. The hydraulic damper of claim 3, wherein the frequency selection valve further comprises a limiting plate arranged on a side of the bypass valve plate facing away from the first opening, wherein both the limiting plate and the bypass valve plate are sleeved on the bypass valve, and a radial outer side of the limiting plate is spaced a predetermined distance from a radial outer side of the bypass valve plate along the axial direction of the piston rod.

6. The hydraulic damper of claim 3, wherein the frequency selection membrane assembly comprises:
a frequency selection membrane having a first side and a second side, wherein the first side of the frequency selection membrane is coupled to the valve housing; and
a frequency selection membrane slide seat coupled to the second side of the frequency selection membrane and the bypass valve, slidably sleeved on the piston rod and defining the bypass flow gap with the piston rod;
wherein in a case where the pressure of the frequency selection lower chamber is greater than the pressure of the frequency selection upper chamber, the frequency selection membrane is elastically deformed to move the frequency selection membrane slide seat and the bypass valve towards the flexible membrane assembly, in a case where the pressure of the frequency selection lower chamber is less than or equal to the pressure of the frequency selection upper chamber, the frequency selection membrane is reset to move the frequency selection membrane slide seat and the bypass valve away from the flexible membrane.

7. The hydraulic damper of claim 4, wherein the valve housing comprises:
a valve housing body having a first end and a second end along the axial direction of the piston rod;
an upper valve cover arranged on the first end of the valve housing body, wherein the second opening is provided on the upper valve cover;
a lower valve cover arranged on the second end of the valve housing body, wherein the first opening is provided on the lower valve cover; and
a frequency selection pinhole seat detachably arranged inside the valve housing body;
wherein an extension direction of the frequency selection pinhole is perpendicular to the axial direction of the piston rod, a part of the frequency selection pinhole is formed on the valve housing body, and another part of the frequency selection pinhole is formed on the frequency selection pinhole seat.

8. The hydraulic damper of claim 7,
wherein a first clamping groove is defined between the upper valve cover and the valve housing body, and the first side of the flexible membrane is fixed in the first clamping groove;
wherein the flexible membrane assembly further comprises a locking ring, and the locking ring is sleeved outside the flexible membrane slide seat and defines a second clamping groove with the flexible membrane slide seat, and the second another side of the flexible membrane is fixed in the second clamping groove.

9. The hydraulic damper of claim 1, further comprising a first limiting nut and a second limiting nut, wherein the first limiting nut and the second limiting nut are arranged respectively on two sides of the frequency selection valve along the axial direction of the piston rod, and the first limit nut and the second limit nut are threaded with the piston rod and clamp the frequency selection valve.

10. A vehicle, comprising a hydraulic damper, wherein the hydraulic damper comprises:
a cylinder barrel;
a piston valve, arranged inside the cylinder barrel and slidable relative to the cylinder barrel with damping, and dividing a chamber of the cylinder barrel into a compression chamber and a recovery chamber, wherein the compression chamber and the recovery chamber are filled with oil fluid;
a piston rod, having a first end threaded through the recovery chamber and coupled with the piston valve, and a second end extending outside the cylinder barrel, wherein a bypass flow channel having a first end and a second end is arranged inside the piston rod, and the first end of the bypass flow channel is in communication with the compression chamber; and
a frequency selection valve, arranged inside the recovery chamber, arranged on the piston rod and spaced a preset distance from the piston valve along an axial direction of the piston rod, wherein the frequency selection valve is in communication with the second end of the bypass flow channel;
wherein in a case where an excitation frequency borne by the hydraulic damper is higher than a preset frequency, the frequency selection valve is opened to enable the bypass flow channel to be in communication with the recovery chamber; and
in a case where an excitation frequency borne by the hydraulic damper is lower than the preset frequency, the frequency selection valve is closed to block the bypass flow channel from communicating with the recovery chamber.

11. The vehicle of claim 10, wherein the frequency selection valve comprises:
a valve housing fixedly sleeved on the piston rod, having a first end close to the piston valve and a second end away from the piston valve, wherein the first end of the valve housing is provided with a first opening, and the second end of the valve housing is provided with a second opening;
a bypass valve arranged inside the valve housing and close to the first opening, wherein the bypass valve is movable along the axial direction of the piston rod; and
a frequency selection component arranged inside the valve housing and close to the second opening,
wherein in a working condition that the piston valve moves towards the recovery chamber, in a case where the excitation frequency borne by the hydraulic damper is higher than the preset frequency, the frequency selection component drives the bypass valve to be separated from the valve housing to enable the first opening to be in communication with the bypass flow channel, and in a case where the excitation frequency borne by the hydraulic damper is lower than the preset frequency, the frequency selection component drives the bypass valve to be in contact with the valve housing to block the bypass flow channel from communicating with the first opening; and
wherein in a working condition that the piston valve moves towards the compression chamber, the bypass valve is in contact with the valve housing to block the bypass flow channel from communicating with the first opening.

12. The vehicle of claim 11, wherein the frequency selection component comprises:
a flexible membrane assembly having a first side and a second side, wherein the first side of the flexible membrane assembly is fixedly coupled to the valve housing, and the second side of the flexible membrane assembly is slidably sleeved on the piston rod; and
a frequency selection membrane assembly having a first side and a second side, wherein the first side of the frequency selection membrane assembly is coupled to the valve housing, and the second side of the frequency selection membrane assembly is slidably sleeved on the piston rod and coupled to the bypass valve, wherein a bypass flow gap having a first end and a second end is defined between an inner wall of the frequency selection membrane assembly and an outer wall of the piston rod, and the first end of the bypass flow gap is in communication with the bypass flow channel;
wherein a bypass valve plate is provided on the bypass valve, a bypass chamber in communication with the first opening is defined between the bypass valve plate and the valve housing, and a flexible chamber in communication with the second opening is defined between the flexible membrane assembly and the valve housing;
wherein the frequency selection membrane assembly, the valve housing, and the flexible membrane assembly jointly define a frequency selection upper chamber, and the frequency selection membrane assembly, the valve housing, and the bypass valve jointly define a frequency selection lower chamber, wherein the valve housing is provided with a frequency selection pinhole, and the recovery chamber is in communication with the frequency selection upper chamber through the frequency selection pinhole,
wherein in a case where a pressure of the flexible chamber is greater than a pressure of the frequency selection upper chamber, the flexible membrane assembly moves towards the frequency selection membrane assembly to block the second end of the bypass flow gap from communicating with the frequency selection upper chamber, and in a case where the pressure of the flexible chamber is less than or equal to the pressure of the frequency selection upper chamber, the flexible membrane assembly moves away from the frequency selection membrane assembly to enable the second end of the bypass flow gap to be in communication with the frequency selection upper chamber;
wherein in a case where a pressure of the bypass chamber is greater than a pressure in the frequency selection lower chamber and exceeds a preset threshold, the bypass valve plate is elastically deformed to enable the bypass chamber to be in communication with the frequency selection lower chamber, and in a case where the pressure of the bypass chamber is less than or equal to the preset threshold, the bypass valve plate is reset to block the bypass chamber from communicating with the frequency selection lower chamber; and
wherein in a case where a pressure of the frequency selection lower chamber is greater than the pressure of the frequency selection upper chamber, the frequency selection membrane assembly drives the bypass valve to move towards the flexible membrane assembly to enable the first opening to be in communication with the bypass flow channel and the bypass chamber, and to block the second end of the bypass flow gap from communicating with the frequency selection upper chamber, and in a case where the pressure of the frequency selection lower chamber is less than or equal to the pressure of the frequency selection upper chamber, the frequency selection membrane assembly drives the bypass valve to move away from the flexible membrane assembly to block the first opening from communicating with the bypass flow channel and the bypass chamber, and to enable the second end of the bypass flow gap to be in communication with the frequency selection upper chamber.

13. The vehicle of claim 12, wherein the flexible membrane assembly comprises:
a flexible membrane having a first side and a second side; and
a flexible membrane slide seat slidably sleeved on the piston rod;
wherein the first side of the flexible membrane is coupled to the valve housing, and the second side of the flexible membrane is coupled to the flexible membrane slide seat;
wherein in a case where the pressure of the flexible chamber is greater than the pressure of the frequency selection upper chamber, the flexible membrane is elastically deformed to move the flexible membrane slide seat towards the frequency selection membrane assembly, and in a case where the pressure of the flexible chamber is less than or equal to the pressure of the frequency selection upper chamber, the flexible membrane is reset to move the flexible membrane slide seat away from the frequency selection membrane assembly.

14. The vehicle of claim 12, wherein the frequency selection valve further comprises a limiting plate arranged on a side of the bypass valve plate facing away from the first opening, wherein both the limiting plate and the bypass valve plate are sleeved on the bypass valve, and a radial outer side of the limiting plate is spaced a predetermined distance from a radial outer side of the bypass valve plate along the axial direction of the piston rod.

15. The vehicle of claim 12, wherein the frequency selection membrane assembly comprises:
a frequency selection membrane having a first side and a second side, wherein the first side of the frequency selection membrane is coupled to the valve housing; and
a frequency selection membrane slide seat coupled to the second side of the frequency selection membrane and the bypass valve, slidably sleeved on the piston rod and defining the bypass flow gap with the piston rod;
wherein in a case where the pressure of the frequency selection lower chamber is greater than the pressure of the frequency selection upper chamber, the frequency selection membrane is elastically deformed to move the frequency selection membrane slide seat and the bypass valve towards the flexible membrane assembly, in a case where the pressure of the frequency selection lower chamber is less than or equal to the pressure of the frequency selection upper chamber, the frequency selection membrane is reset to move the frequency selection membrane slide seat and the bypass valve away from the flexible membrane.

16. The vehicle of claim 13, wherein the valve housing comprises:
a valve housing body having a first end and a second end along the axial direction of the piston rod;
an upper valve cover arranged on the first end of the valve housing body, wherein the second opening is provided on the upper valve cover;
a lower valve cover arranged on the second end of the valve housing body, wherein the first opening is provided on the lower valve cover; and
a frequency selection pinhole seat detachably arranged inside the valve housing body;
wherein an extension direction of the frequency selection pinhole is perpendicular to the axial direction of the piston rod, a part of the frequency selection pinhole is formed on the valve housing body, and another part of the frequency selection pinhole is formed on the frequency selection pinhole seat.

17. The vehicle of claim 16,
wherein a first clamping groove is defined between the upper valve cover and the valve housing body, and the first side of the flexible membrane is fixed in the first clamping groove;
wherein the flexible membrane assembly further comprises a locking ring, and the locking ring is sleeved outside the flexible membrane slide seat and defines a second clamping groove with the flexible membrane slide seat, and the second another side of the flexible membrane is fixed in the second clamping groove.

18. The vehicle of claim 10, wherein the hydraulic damper further comprising a first limiting nut and a second limiting nut, wherein the first limiting nut and the second limiting nut are arranged respectively on two sides of the frequency selection valve along the axial direction of the piston rod, and the first limit nut and the second limit nut are threaded with the piston rod and clamp the frequency selection valve.
